(19) United States
(12) Patent Application Publication
(10) Pub. No.: US 2010/0030598 A1
(43) Pub. Date: Feb. 4, 2010

(54) PLATFORM PROVISIONING SYSTEM AND METHOD

(75) Inventors: Chandra H. Kamalakantha, Plano, TX (US); Sanjay Lobo, Plano, TX (US); Charles E. Bess, McKinney, TX (US); Jeff Sandler, Kingston, WA (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Electronic Data Systems Corporation, Plano, TX (US)

(21) Appl. No.: 12/184,835

(22) Filed: Aug. 1, 2008

(51) Int. Cl. G06Q 10/00

(52) U.S. Cl. 705/7

(57) ABSTRACT

There is provided a platform provisioning system and method. More specifically, in one embodiment, there is a computerized method of provisioning a new environment to an application platform, the method including analyzing a current state of the application platform, defining business requirements for the new environment, defining technical requirements for the new environment, generating a logical architecture for the new environment based on the business requirements and the technical requirements, performing a gap analysis on the application platform based on the current state of the application platform and the generated logical architecture, generating a technical architecture for the new environment based at least partially on the gap analysis, generating a physical architecture for the new environment based at least partially on the technical architecture, and provisioning the new environment based at least partially on the physical architecture.

### BACKGROUND

Over the past few years, dramatic changes have occurred in IT application platform architectures. The proliferation of the Internet and the World Wide Web has made it much easier to develop and deploy new applications and capabilities. The introduction of multitiered web-based application architectures has caused a shift of computing power from client back to server. The continuing trend toward smaller, cheaper servers has resulted in a dramatic increase in the number of servers. The result of these trends has been an explosion of complexity and scale in the IT application platforms, such as data centers, enterprise systems, data warehouses, and the like. In fact, many modern IT application platforms contain thousands or tens of thousands of servers, networking devices, storage devices and other special-purpose equipment, running an even greater array of operating systems, software, configurations and data. This explosion in the complexity of IT application platforms has made developing new platforms or expanding the capabilities of existing platforms into a complicated and primarily manual process that is typically far from efficient.

### SUMMARY

In one aspect, there is provided a computerized method of provisioning a new environment to an application platform, the method including analyzing a current state of the application platform, defining business requirements for the new environment, defining technical requirements for the new environment, generating a logical architecture for the new environment based on the business requirements and the technical requirements, performing a gap analysis on the application platform based on the current state of the application platform and the generated logical architecture, generating a technical architecture for the new environment based at least partially on the gap analysis, generating a physical architecture for the new environment based at least partially on the technical architecture, and provisioning the new environment based at least partially on the physical architecture.

In another aspect, there is provided a platform provisioning computing system having instructions stored on a computer-readable medium, wherein the instructions are operable to cause a data processing apparatus to analyze a current state of the application platform, define business requirements for the new environment, define technical requirements for the new environment, produce a logical architecture for the new environment based at least partially on the business requirements and the technical requirements, perform a gap analysis on the application platform based on the current state of the application platform and the generated logical architecture, produce a technical architecture for the new environment based at least partially on the gap analysis, produce a physical architecture for the new environment based at least partially on the technical architecture, and provision the new environment based at least partially on the physical architecture.

In still another aspect, there is provided a computer-implemented method for automatically provisioning a new environment to an application platform, the method including receiving a plurality of business requirements, producing a logical architecture corresponding to the business requirements, comparing the logical architecture to an existing environment of the application platform to determine one or more differences between the logical architecture and the existing architecture, and producing a technical architecture corresponding to the one or more differences.

### BRIEF DESCRIPTION OF DRAWINGS

FIG. 1 is a block diagram of an example computing system configured to provision a platform.

FIG. 2 illustrates a block diagram of an example computing platform.

FIG. 3 is a flow chart illustrating an example technique for provisioning a platform with a solution architecture.

FIG. 4 is a flow chart illustrating an example technique for producing a technical architecture.

FIG. 5 is a flow chart illustrating an example technique for provisioning a solution architecture.

Like reference symbols in the various drawings indicate like elements.

### DETAILED DESCRIPTION

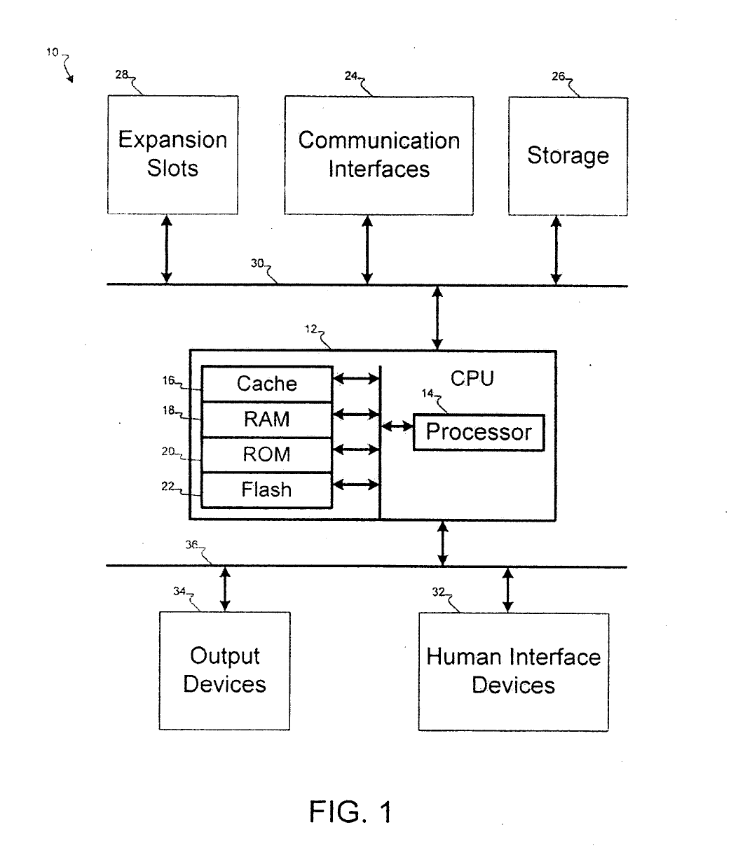

FIG. 1 is a block diagram of an example computing system 10 configured to provision a platform, such as an IT application platform. The computing system 10 may include a central processing unit 12 (“CPU”), which is typically comprised of a microprocessor 14 associated with random access memory (“RAM”) 16 and read-only memory (“ROM”) 16. Often, the CPU 12 is also provided with cache memory 18 and programmable FlashROM 20. The interface 22 between the microprocessor 14 and the various types of CPU memory is often referred to as a “local bus”, but also may be a more generic or industry standard bus.

The computing system 10 may also include one or more communication interfaces 24 that may enable the CPU 12 to interface with remote computers, storage, and/or other resources. For example, the communication interfaces 24 may include a network connection, including an Ethernet, Gigabit Ethernet, or other suitable form of network card. The communication interfaces may also include a wireless interface, such as 802.11, 802.16, LTE, or any other suitable wireless standard. The communication interfaces may also include local connections, such as one or more universal serial bus (“USB”) ports, IEEE 1394 ports, or Serial ATA ports. In some embodiments, other communication interfaces may also be employed.

The computing system 10 may also include one or more storage devices 26, such as a hard-disk drives (“HDD”), solid state disks (“SSD”), floppy disk drives, compact disc drives (CD, CD-R, CD-RW, DVD, DVD-R, etc.), and proprietary disk and tape drives. As will be described below, in some embodiments, storage devices may accessed by the computing system 10 over a computer network.

The computing system 10 may also be equipped with one or more expansion slots 28, such as Peripheral Component Interconnect (“PCI”), PCI Express, or other suitable or proprietary interface slots for the addition of other hardware, such as sound cards, memory boards, and graphics accelerators. Additionally, the expansion slots may also include one or more external expansion slots allowing the user the ability to easily install and remove hardware expansion devices, such as solid state storage devices or optical storage devices. The storage devices 26, communication interfaces 24, and expansion slots 28 may be interconnected with the CPU 12 via a standard or industry open bus architecture 30, such as ISA, EISA, or PCI, or the bus 30 may be of a proprietary design.

The computing system 10 is usually provided with one or more user human input devices 32 such as a keyboard, mouse, or a touch-screen display. For example, in embodiment where the computing device includes a personal computer, a full size keyboard is often provided along with a mouse or pointer device. In the case where the computing device 10 is a web-enabled wireless telephone, a simple keypad may be provided with one or more function-specific keys. In the case of a PDA, a touch-screen is usually provided, often with handwriting recognition capabilities.

The computing system 10 may also include one or more output devices 34, such as a display, including a Cathode Ray Tube (“CRT”), a Thin Flat Transistor (“TFT”) array, or a simple set of light emitting diodes (“LED”) or liquid crystal display (“LCD”) indicators. The output devices 34 may also include one or more speakers, which may be used to reproduce audio and music, such as the speaker of a wireless telephone or the speakers of a personal computer. The human interface devices 32 and output devices 34 may be directly interconnected to the CPU 12 via a bus 36, which may be proprietary or follow an industry open buses standard, such as ISA, EISA, PCI, etc.

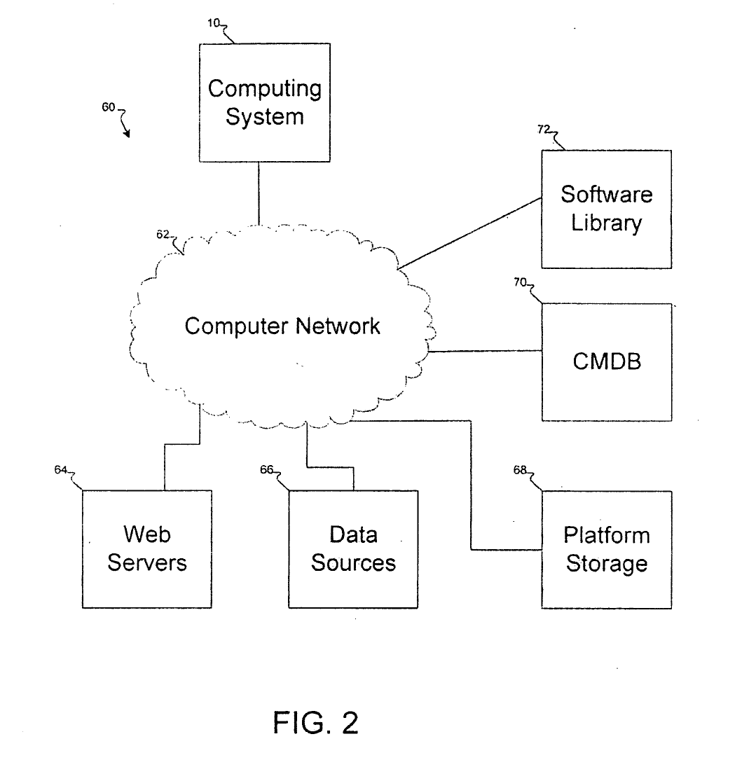

FIG. 2 illustrates a block diagram of a computer platform 60. As shown, the computing system 10 may be coupled to or a part of the platform 60. In various embodiments, the platform 60 may include any one of a number of different types of system, including enterprise systems, e-commerce systems, portal systems, data-warehouses, web-hosting systems, and the like. For example, in some embodiments, the platform 60 may be an IT application platform configured to run an enterprise e-commerce system.

In addition to the computing system 10, the platform 60 may include a computer network 62, such as a corporate intra-net, the intranet, and/or another suitable form of computer network. The computer network 62 interconnects the computing system 10 with the other components of the platform 60. In the illustrated embodiment, the computer network 62 is also coupled to one or more web-servers 64 and one or more data sources 66. The platform 60 may also include platform-related storage 68. As will be described below, storage 68 may include information on the architecture of platform 60, information on the platform frameworks, and/or test scenarios. The platform 60 may also include a configuration management database (“CMDB”) 70 and one or more software libraries 72.

As mentioned above, the computing system 10 may be configured to provision, either fully or partially, the platform 60. In alternate embodiments, the computing system 10 may be configured to provision a new platform from scratch. In these embodiments, one or more of the components of the platform 60 may be absent. For example, the software libraries 72 and CMDB 70 may be included in the platform 60, but other components, such as the web servers 64 and data sources 66, may be initially absent from the platform 60.

In some embodiments, provisioning the platform 60 may include creating, assembling, and/or managing an IT Application Platform Architecture, including, but not limited to, the development, testing, model-office, and production environment. Additionally, in some implementations, the computing system 10 may be configured to also set up role-based access control, infrastructure virtualization, and/or Data Center Markup Language (“DCML”) constructs to the platform 60, which may also be referred to as the “environment” 60.

The computing system 10 may also be configured to automatically create and provision Standardized Development and Runtime Environment (“SDRE”) for the platform 60. In some embodiments, the computing system 10 may execute a wizard-driven Graphical User Interface (“GUI”) that is configured to perform one or more of the following steps to provision the appropriate SDRE:

(1) Capturing development and operations information such as tools, processes, architecture, Service Level Agreement (“SLAs”), and/or Servers;

(2) Configuring Network topology, Security, Policies, Operational requirements, etc;

(3) Generating a set of declarative specifications (e.g., XML files); and/or

(4) Executing the declarative specifications to deploy one or more SDREs.

It will be appreciated, however, that the computing system 10 in FIG. 1 and the platform 60 shown in FIG. 2 are merely examples of computer hardware suitable to be employed with the provisioning solution set forth herein. In alternate embodiments, other computing systems may be employed. For example, the provisioning system may be employed with computing system employing Solaris containers, 64-bit Intel computing, and so forth.

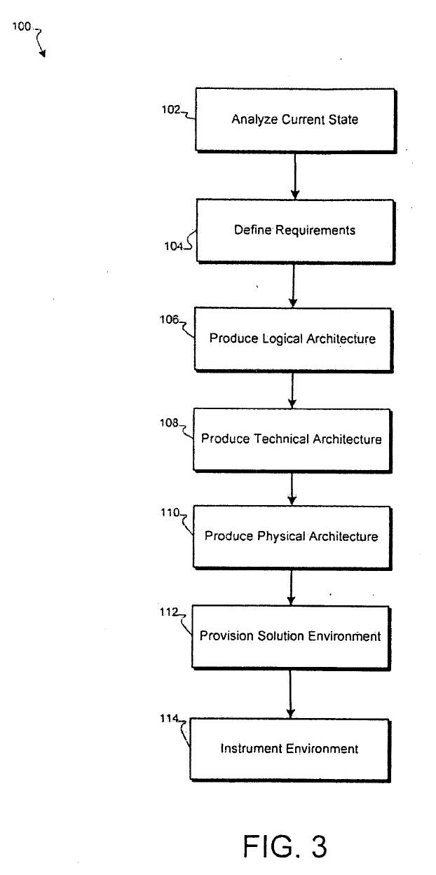

FIG. 3 is a flow chart illustrating an exemplary technique 100 for provisioning a platform, such as the platform 60, with a solution architecture. In some embodiments, the computing system 10 is configured to execute the technique 100. For example, the computing system 10 may execute one or more software or firmware modules embodying the steps of technique 100. In other embodiments, a variety of suitable types of computers and/or computing system may be configured to execute the technique 100.

As shown by block 102 of FIG. 3, the technique 100 may include analyzing the current state of the platform 60. Analyzing the current state may include capturing the current “as-is” and future “to-be” landscape of the technology currently deployed as part of the platform 60. This analysis may establish the principles which lead to the constraints and assumptions that need to be adhered to for to determine a provisioning solution for the platform. The current state of the platform 60 may include accessing or capturing current state information. In some embodiments, current state information for the platform 60 may include:

(1) Platform architecture principles;

(2) Architecture assumptions and constraints, including current technical footprint required (e.g., platform, tools, applications, process, license agreement, etc.);

(3) Reusable assets, such as processes, software assets, hardware assets, etc; and

(4) Pre-existing test scenarios for the platform 60.

Additionally, in some embodiments, analyzing the current state of the platform may also include accessing business principles.

The computing system 10 may access the current state information from a storage location within the platform 60. For example, the computing system 10 may access the current state information from a storage location within the platform storage 68. In some embodiments, the computing system 10 may determine the current state information by querying or scanning the platform 60. For example, the computing system 10 may query each of the components of the platform 60 to determine their hardware and software assets. In still other embodiments, the computing system 10 accesses some current state information from a storage location and queries the platform 60 for some of the current state information.

The technique 100 may also include defining requirements, such as business and technical requirements, as indicated by block 104. Defining business and technical requirements may include capturing the business and/or technical requirements for creating a system that automates one or more desired business processes. For example, defining requirements can include gathering requirements related to a business architecture, data architecture, and an application architecture (including interface points, etc.), and/or a technology architecture (if any including any integration approach, etc.). In one example system, the requirements may be gathered from a user though an input, such as an input from a graphical user interface, such as a wizard driven graphical user interface asking a series of questions to a user. In some embodiments defining the requirements may also include determining one or more service level agreements (“SLAs”) and/or non-functional requirements (“NFRs”), and the like.

The technique 100 may also include producing or generating a logical architecture, as indicated by block 106 of FIG. 3. In some embodiments, producing a logical architecture includes utilizing a platform framework which includes styles of computing, implementation patterns, and/or reference stacks to produce a logical architecture for the requirements gathered at 104. As those of ordinary skill will appreciate, styles of computing represent a class of applications which exhibit particular characteristics. For example, in various embodiments, the styles of computing may include one or more of the following: online transaction processing (“OLTP”), workflow, event processing, traditional batch, historical analysis, near-time decisioning, and real-time decisioning. Implementation patterns offer a high-level abstract representation of how a set of problems might be resolved within a particular style of computing. For example, suitable implementation patterns include enterprise web apps, portal web apps, and lightweight web apps.

In one example, block 106 involves using expert systems logic having a series of question to establish whether an existing application fits a desired style of computing and its related implementation pattern. This approach can help to drive consistency in the approach and leverage the benefits of an existing set of solution stacks. Producing the logical architecture may include accessing a catalog of implementations that the platform 60 supports, such as Microsoft.NET reference stack, a Borland reference stack, and/or a J2SE reference stack. A sample XML fragment that is built while executing this block in one embodiment is provided below:

```
<?xml version=“1.0” encoding=“utf-8” ?>
<LogicalArchitecture>
    <SoC OnlineTransactionProcessing=true />
    <Pattern EnterpriseWebApplication=true/>
    <Stack Portal=SharePoint/>
</LogicalArchitecture>
```

In some embodiments, producing the logical architecture also includes identifying the gaps between a proposed “to-be” logical architecture and an “as-is” technical footprint to identify the improvements areas. This process, which is referred to as “gap analysis” improves the chances that a proposed solution architecture will meet or exceed the defined requirements, including and not limited to SLAs, NFRs, and the like.

As indicated by block 108, the technique 100 may also include producing or generating a technical architecture for requirements defined in block 104 and the logical architecture produced in block 106. In some embodiments, producing the technical architecture also includes addressing the gaps that were identified during a gap analysis. In many examples, the main differences between the logical architecture and the technical architecture will be at the logical architecture level, where the OS platforms are not identified and/or where the product sub-assembly is not identified or elaborated. In some embodiments, the “Build vs Buy” decision will be performed prior to producing the technical architecture.

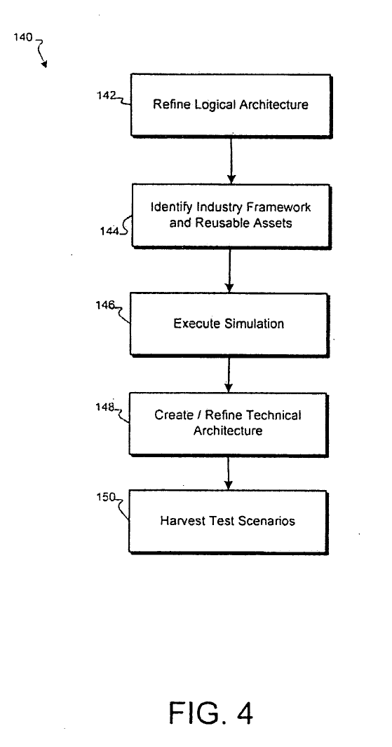

FIG. 4 is a flow chart illustrating an exemplary technique 140 for producing a technical architecture in accordance with some embodiments. As shown in block 142, the technique of FIG. 4 may begin with refining the logical architecture, such as by addressing the gaps identified during the gap analysis. For example, the proposed architecture may call out for utilizing Microsoft MSMQ as messaging backbone since it was established as constraint in block 102, but one of the defined non-functional requirements may call out for processing a large amount of messages per second (e.g., thousands of messages per second). In this situation, the technique 140 may refine the logical architecture to utilize a mainstream/UDP type of product, such as TIBCO Rendezvous or TCP based TIBCO EMS (Enterprise Message Service) either of which are able to handle thousands of messages per second. A sample XML fragment that may be created during the refining of the logical architecture is reproduced below:

```
<LogicalArchitecture>
    <SoC OnlineTransactionProcessing=true />
    <Pattern EnterpriseWebApplication=true/>
    <Stack Portal=SharePoint/>
</LogicalArchitecture>
```

As indicated by block 144, the technique 140 may also include identifying one or more reusable business processes that are available as business services for the requirements gathered in block 104. This block may involve running a match algorithm to match one or more of the defined requirements against an industry framework to identify business services that are correlated with a specific industry or across an industry segment. In addition, other reusable assets, such as logging, exception handling, wrappers for database I/O, data services caching, UI building blocks, and the like could also be identified. A sample XML fragment that is built while identifying industry framework and reusable assets is reproduced below:

```
<?xml version=“1.0” encoding=“utf-8” ?>
    <ReusableAssets>
        <BusinessProces>
          <Process name=”Data Synchronization” source=”UCCNET”
    process=”B2B” />
        </BusinessProcess>
        <HardwareAssets>
          <Hardware name=”Monitoring” server=”server_name1”
    dependency=”server_b1” uptime=”24×7”/>
        </HardwareAssets>
        <SoftwareAssets>
        <Software name=”Logging” assembly=”pkg.logging.log”
    dependency=”assembly_b” hosted_on=”server_b”/>
        <Software name=”Monitoring”
assembly=”pkg.logging.monitoring”
dependency=”logging hosted_on=”server_b”/>
        </SoftwareAssets>
</ReusableAssets>
```

The technique 140 may next include defining a simulation approach, as indicated by block 146. This block may include running a simulation of the Logical Architecture refined in block 142 to ensure it scales per the requirements and addresses any gaps identified during gap analysis. The end product of this module may be a refined logical architecture corresponding to logical architecture produced in block 106 of technique 100.

As indicated by block 148, the technique 140 may next involve creating an actual technical architecture for the requirements defined in block 104 and logical architecture established in block 146. Notably, at this point in the technique 140, one difference between the “as-designed” logical architecture and the “to-be” technical architecture is that at the logical architecture level, particular OS platforms are not identified and the product sub assembly is similarly not identified or elaborated. A sample XML fragment that is built while creating the technical architecture is reproduced below:

```
<?xml version=“1.0” encoding=“utf-8” ?>
<TechnicalArchitecture>
<!-- This XML captures only the ones that are true -->
    <Hardware>
        <Midrange>
            <HPProliant=true />
            <HPSuperdome=true/>
        </Midrange>
    </Hardware>
    <Software>
        <ProcessModeling Visio=true />
        <Presentation dotNet=true >
          <Portal>
            <SharePoint=true/>
          </Portal>
          <AppServer>
            <dotNet version=3.5 />
          </AppServer>
        <Presentation/>
        <ProcessExecutionPlatform>
        <BizTalk> true </BizTalk>
        </ProcessExecutionPlatform>
        <Integration>
        <BizTalk> true </BizTalk>
        <Messaging>
          <MSMQ> true </MSMQ>
        </Messaging>
        </Integration>
        <RDBMS>
          <Oracle version=10g />
        </RDBMS>
    </Software>
    <Hosting>
    <Hosting private=true internetfacing=true/>
        <TCOMonthly hardware=2000 support=2000/>
        <Development perDeveloper=200 />
        <Testers perTester=100 />
    </Hosting>
</ TechnicalArchitecture >
```

As indicated by block 150, the technique 140 may also involve harvesting test scenarios for testing an eventual end-to-end architecture. The technical architecture created in block 148 depicts reusable assets and its related interfaces, and test scenarios to test the reusable assets may be harvested in this block. In addition, in some embodiments, the system interfaces identified in block 102 may be elaborated further to create more meaningful test scenarios that could be executed in automated testing tools. In one embodiment, the test data would be in native format for the testing tool of choice.

Returning now to FIG. 3, the technique 100 may continue with producing a physical architecture, as shown in block 110. For example, the technique 100 may produce a physical architecture for requirements defined in block 104 and the technical architecture produced in block 108. This physical architecture may include one or more physical and/or virtual servers. Notably, at this point in the technique 100, one of the differences between physical architecture and technical architecture is at the physical architecture level where one or more of the server names, storage arrays, virtual local area networks, service IDs used, and the like are depicted along with product sub assembly and OS platform versions. In some embodiments, block 110 involves utilizing DCML constructs to depict the physical architecture.

The technique 100 may next involve provisioning a solution environment, as indicated by block 112. In some example systems, block 112 includes orchestrating various operations of provisioning the application environment (e.g., development, test and/or production) along with role based access control for users, policy management, SLAs (Service Level Agreements), etc. Block 112 may also include updating the CMDB 70 and/or the software library 72.

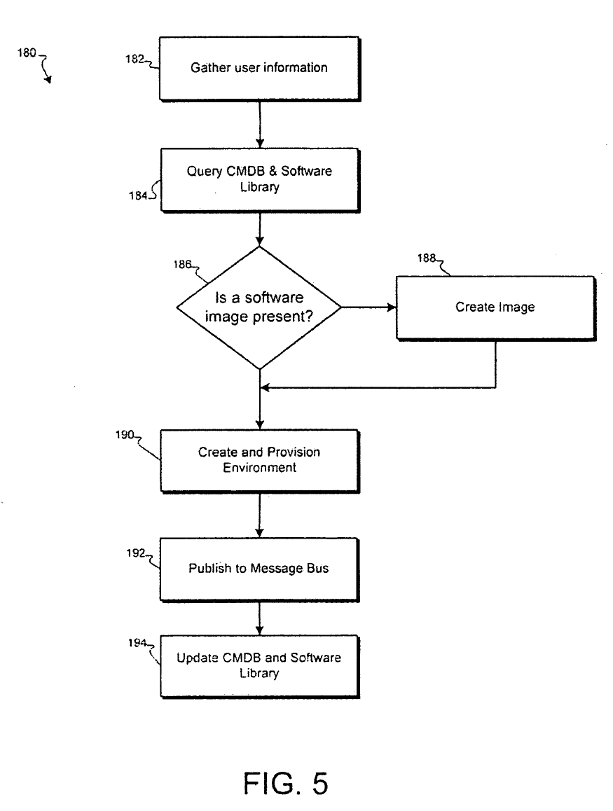

FIG. 5 is a flow chart illustrating a technique 180 for provisioning a solution environment. The technique 180 include gathering user information, as shown in block 182. In some examples, gathering user information includes capturing the users who would be using the solution assets with appropriate access control, such as role based access control (“RBAC”), corporate policies, and the like. In addition, block 182 may also include capturing information on whether the solution assets have to be provisioned as standalone (not leveraged with other customers), thin client access, offline support, and so forth.

The technique 180 may also include querying the CMDB 70 and/or the software library 72 to determine if the prescribed architecture exists in a Software Definitive Library (“SDL”) as a software image, as indicated by block 184. If the prescribe architecture does exist, a reference to the software images is returned so that it can be provisioned on appropriate operating system and hardware platform. If the software image does not exist in the SDL (block 186), the technique 180 may initiate a process to create a software image to be added to the SDL, as shown in block 188.

Next, the technique 180 may include creating and provisioning the solution environment (i.e., the solution architecture), as indicated by block 190. In some embodiments, creating and provisioning the solution environment includes registering users in the directory service, such as the Lightweight Directory Access Protocol (“LDAP”), in an appropriate group in order to establish role based access control. For example, block 190 can include registering user usage for metrics driven business requirements (e.g., billing) and audit purposes, and for archival and retrieval for future projects. Provisioning the solution environment may also involve executing “Sysprep” (Microsoft's System Preparation Utility) on the software image (if windows platform) to prepare one or more operating systems for disk cloning and then cloning the software image to the server name that was produced in block 110. Block 190 may also involve administrative tasks such as adding the users identified in block 182 to the provisioned servers, staging the server in an appropriate VLAN (Virtual Local Area Network), and the like.

After provisioning the environment, the technique 180 may include publishing the platform architecture that was provisioned in block 190 to a message bus, as shown in block 192. In one example system, the message bus message will conform to a common canonical document used by other related platforms (e.g., platforms in the same company). Publishing to the message bus may allow additional subscribers to access the provisioned environment for familiarity, may eliminate or reduce point-to-point interfaces, and may reduce integration complexities. Lastly, as shown in block 194, the technique 180 may involve updating the CMDB 70 with the message bus message and publishing any new or updated software images to the software library 70 (if not previously done).

Returning once again to FIG. 3, the technique 100 may include instrumenting the solution environment, as indicated by block 114. Instrumentation is performed to collect quality metrics to better understand the behavior (e.g., the capabilities or deficiencies) at the various stages of lifecycle of the environment. In various embodiments, instrumenting the solution architecture may involve promoting the architecture to various stages of software lifecycle, such as de-commissioning of the architecture, setting up billing structure, scaling on demand, operational BI, and/or addressing other service delivery and service management tasks. In some example systems, instrumenting the architecture employs features that are metadata driven.

The embodiments and example system described above can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard or keypad and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Although a few implementations and example systems have been described in detail above, other modifications are possible. Accordingly, other implementations are within the scope of the following claims:

What is claimed is:

1. A computerized method of provisioning a new environment to an application platform, the method comprising:
analyzing a current state of the application platform;
defining business requirements for the new environment;
defining technical requirements for the new environment;
generating a logical architecture for the new environment based on the business requirements and the technical requirements;
performing a gap analysis on the application platform based on the current state of the application platform and the generated logical architecture;
generating a technical architecture for the new environment based at least partially on the gap analysis;
generating a physical architecture for the new environment based at least partially on the technical architecture; and
provisioning the new environment based at least partially on the physical architecture.

2. The computerized method of claim 1, comprising instrumenting the new environment.

3. The computerized method of claim 1, wherein analyzing the current state of the application platform comprises harvesting one or more test scenarios from a storage location.

4. The computerized method of claim 1, wherein generating the logical architecture comprises generating the logical architecture based at least partially on a platform framework.

5. The computerized method of claim 4, wherein the platform framework includes one or more styles of computing.

6. The computerized method of claim 4, wherein the platform framework includes a reference stack.

7. The computerized method of claim 1, wherein generating a technical architecture for the new environment comprises:
refining the logical architecture;
identifying one or more reusable assets associated with the refined logical architecture;
executing a simulation for the refined logical architecture; and
generating a technical architecture based at least partially on the simulation.

8. The computerized method of claim 7, comprising, identifying and retrieving one or more test scenarios associated with the generated technical architecture.

9. The computerized method of claim 1, wherein provisioning the new environment based on the physical architecture comprises:
gathering user information associated with the new environment;
querying a software library for an image file associated with the new environment; and
provisioning the new environment based on the image file.

10. The computerized method of claim 9, comprising:
generating a new image file if the software library does not include an image file associated with the new environment, wherein the provisioning based on the image file comprises provisioning based on the new image file.

11. The computerized method of claim 9, comprising publishing a message to the message bus, wherein the message is indicative of one or more aspects of the new environment.

12. The computerized method of claim 9, wherein querying the software library comprises querying a definitive software library.

13. The computerized method of claim 1, wherein defining business requirements for the new environment comprises receiving one or more business requirements via a graphical user interface.

14. The computerized method of claim 13, wherein defining business requirements for the new environment comprises receiving one or more non-functional requirements.

15. A platform provisioning computing system comprising instructions stored on a computer-readable medium, wherein the instructions are operable to cause a data processing apparatus to:
analyze a current state of the application platform;
define business requirements for the new environment;
define technical requirements for the new environment;
produce a logical architecture for the new environment based at least partially on the business requirements and the technical requirements;
perform a gap analysis on the application platform based on the current state of the application platform and the generated logical architecture;
produce a technical architecture for the new environment based at least partially on the gap analysis;
produce a physical architecture for the new environment based at least partially on the technical architecture; and
provision the new environment based at least partially on the physical architecture.

16. The computing system of claim 15, wherein the provisioning computing system is configured to provision an IT application platform architecture.

17. A computer-implemented method for automatically provisioning a new environment to an application platform, the method comprising:
receiving a plurality of business requirements;
producing a logical architecture corresponding to the business requirements;
comparing the logical architecture to an existing environment of the application platform to determine one or more differences between the logical architecture and the existing architecture; and
producing a technical architecture corresponding to the one or more differences.

18. The computer-implemented method of claim 17, comprising provisioning the new environment based on the technical architecture.

19. The computer-implemented of claim 17, wherein producing the logical architecture comprises employing one or more reference stacks associated with the application platform.

20. The computer-implemented of claim 17, comprising publishing the technical architecture to a message bus.
